(19) United States
(12) Patent Application Publication
(10) Pub. No.: US 2006/0211298 A1
(43) Pub. Date: Sep. 21, 2006

(54) Electrical component connector

(75) Inventors: Edoardo Campini, Mesa, AZ (US); Mark Summers, Phoenix, AZ (US)

Correspondence Address: INTEL CORPORATION, P.O. BOX 5326, SANTA CLARA, CA, 95056-5326, US

(73) Assignees: Edoardo Campini; Mark Summers

(21) Appl. No.: 11/085,966

(22) Filed: Mar. 21, 2005

(51) Int. Cl. H01R 11/00

(52) U.S. Cl. 439/502

(57) ABSTRACT

Embodiments of the invention are generally directed to a connector. In one embodiment, the connector includes a plurality of flexible circuit partitions and a first mating portion to receive and couple a contact for a device to a first end of one or more flexible circuit partitions. The connector also includes a second mating portion to receive and couple a contact for another device to a second end of the one or more flexible circuit partitions. A connector housing is connected to the other device to contain the first and second mating portions. Each flexible circuit partition further includes a twist to increase a range of movement along three axes of movement in which the first mating portion receives and couples the device's contact to the first end of one or more flexible circuit partitions without a proportional increase in movement of either end of each flexible circuit partition.

### TECHNICAL FIELD

Embodiments of the invention generally relate to the field of electronic systems, and more particularly, to an electrical component connector.

### BACKGROUND

Computing systems are made up of many electrical components coupled together by connectors. These connectors may contain conductive traces or “interfaces” to couple one or more contacts of an electronic component or device to one or more contacts of another electronic device. When coupling devices, the connector needs to accurately align the interfaces to the device's contacts to provide acceptable levels of reliability and communication speed or “throughput.”

Types of computing systems where reliability and throughput are a high priority are computing systems used in typical telecommunication and data centers. These computing systems need a high level of reliability and/or throughput to meet demanding communication or data storage requirements. The equipment used in these computing systems may be designed in compliance with the PCI Industrial Computer Manufacturers Group (PICMG), Advanced Telecommunications Computing Architecture (ATCA) Base Specification, PIGMG 3.0 Revision 1.0, published Dec. 30, 2002 (hereinafter referred to as “the ATCA specification”).

ATCA compliant equipment may include modular platform backplanes to receive and couple to interconnects and/or carrier boards. Carrier boards may also be designed to couple to and receive one or more front accessible modules. These carrier boards and front accessible modules may also be compliant with other specifications. One such specification is the Advanced Mezzanine Card (AMC) Specification, PIGMG AMC.0, Revision 1.0, published Jan. 3, 2005 (hereinafter referred to as “the AMC.0 specification). Carrier boards designed in compliance with the AMC.0 specification are hereinafter referred to as “AMC carrier boards” or “AMC/ATAC carrier boards.” Front accessible modules and connectors designed in compliance with the AMC.0 specification are hereinafter referred to as “AMC modules” and “AMC connectors,” respectively.

A typical AMC module has contacts which are closely spaced or have a small pitch (approximately 0.75 millimeters (mm)). The contact spacing and pitch along with the mechanical dimension deviations/tolerances permitted by both the ATCA and AMC specifications lead to difficulties in obtaining an accurate alignment between AMC module contacts and AMC connector interfaces when coupled. Additionally, AMC module contacts may be designed to operate at a given impedance for a given configuration. Since high frequency (e.g., greater than 1 GHz) input/output (I/O) signals are typically routed from AMC module contacts to AMC connector interfaces, an inaccurate alignment may create an impedance mismatch for the given configuration. Consequently, the impedance mismatch may affect the signal integrity once the AMC module is operational. This may result in an unacceptable level of reliability and/or throughput for an AMC module coupled to an ATCA/AMC carrier board in a telecommunication or data center computing system.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is an isometric view of a typical ATCA/AMC carrier board in which two single-width AMC modules and one double-width AMC module are to couple to typical AMC connectors;

FIG. 2 is an isometric view of a connector, according to one embodiment;

FIG. 3 is a side view of an example portion of the connector coupled to an example portion of a carrier board, according to one embodiment;

FIG. 4 is an isometric view of a module's contacts to be received and coupled to the connector on the example portion of the carrier board, according to one embodiment;

FIG. 5 shows an isometric view of the carrier board in which dual-width modules are to couple to connectors, according to one embodiment; and

FIG. 6 provides a partial view of a modular platform in which the carrier board is received and coupled to a backplane, according to one embodiment.

### DETAILED DESCRIPTION

Embodiments of the invention are generally directed to an electrical component connector. The connector includes a first mating portion to receive a contact for a device and a second mating portion to receive a contact for another device. The connector also includes a flexible circuit to couple the device's contact to the other device's contact. The flexible circuit includes a first end partitioned near the middle and a second end to couple to the other device's contact. The first end of the flexible circuit includes a twist to each partition. The twist is to increase a range of movement along three axes of movement in which the first mating portion receives and couples the device's contact to the first end of the flexible circuit. The range of movement is increased without a proportional increase in movement of the first and second ends of the flexible circuit. A connector housing is connected to the other device to contain the first and second mating portions.

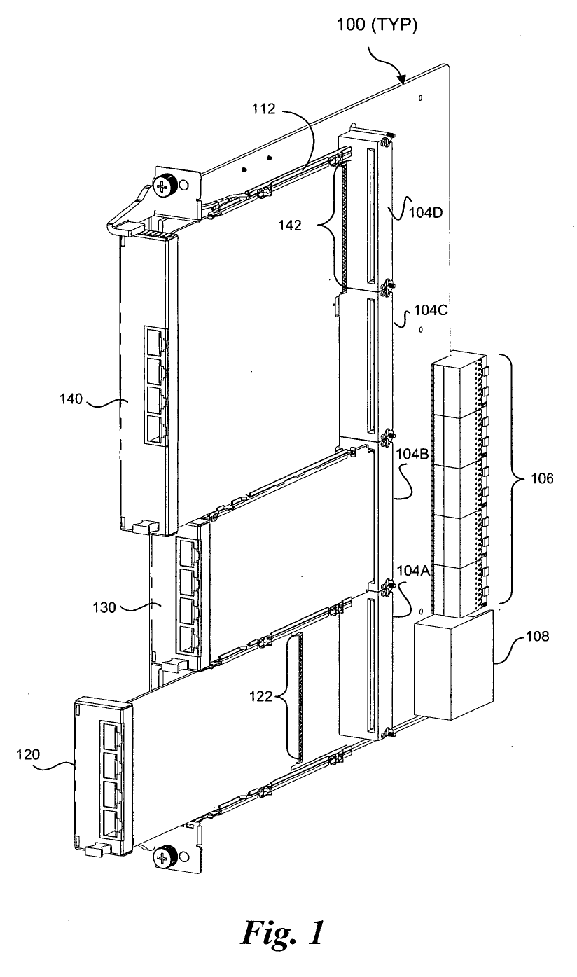

FIG. 1 is an isometric view of a typical ATCA/AMC carrier board 100 in which two single-width AMC modules and one double-width AMC module are to couple to typical AMC connectors. In an ATCA/AMC implementation, carrier board 100 may be enabled to receive and couple AMC modules 120, 130 and 140 to AMC connectors on carrier board 100. As shown in FIG. 1, carrier board 100 is coupled to an AMC module 130 via AMC connector 104B and about to receive and couple to AMC modules 120 and 140 via AMC connectors 104A and 104D, respectively.

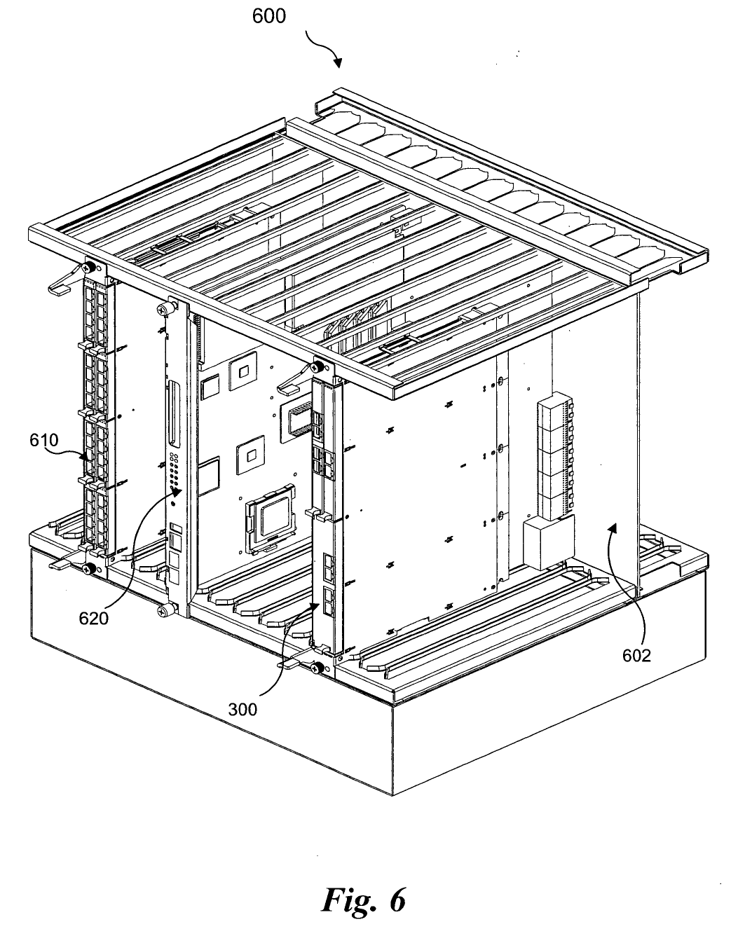

The horizontal (or longitudinal) module edges of AMC modules 120, 130 and 140 are guided via a set of guide rails 112 disposed on opposing sides of carrier board 100. Carrier board 100 also includes a power connector 108 via which power is provided to carrier board 100 from an ATCA backplane (see FIG. 6). Various I/O connectors 106 may be used to route signals to the ATCA backplane, and possibly to other ATCA boards and/or AMC modules similarly coupled to the ATCA backplane.

In general, ATCA/AMC carrier boards may have various configurations. Configurations may vary depending on the type of AMC modules the carrier board is designed to receive and couple. For example, FIG. 1 depicts one configuration where carrier board 100 is to receive and couple to two single-width AMC modules (modules 120 and 130) and one double-width AMC module (module 140).

As described in the AMC.0 specification, AMC connectors may be referred to as basic or extended connector types. The term “basic” is associated with AMC connectors that are equipped with interfaces to receive and couple to an AMC module with contacts on only one side. The term “extended” identifies the connector as having interfaces to receive and couple to AMC modules with contacts on both sides. AMC connectors 104A-D, for example, may include either basic or extended connector types or a combination of both connector types.

Similar to AMC connectors, AMC modules on the vertical (or latitudinal) module edge may have contacts on a single side (basic) or on both sides (extended). For example, contacts 122 may be basic type contacts with contacts on one side of AMC module 120 or may be extended type contacts with contacts on both sides of AMC modules 120.

AMC modules 120 and 130 are depicted as single-width modules and AMC module 120 includes contacts 122. Module 140 is depicted as a double-width AMC module and includes contacts 142. As mentioned previously, the accurate and/or precise alignment of an AMC module's contacts to interfaces in an AMC connector is needed to avoid an impedance mismatch. For example, although AMC module 140 is double the width of single-width AMC modules 120 and 130, contacts 142 are coupled and received into only one AMC connector. This typically occurs in ATCA/AMC carrier board implementations where mechanical dimension tolerances may not allow for an acceptably accurate alignment of two sets of contacts on one double-width module. Thus, when AMC module 140 is coupled to carrier board 100 it is received and coupled through contacts 142 to only AMC connector 104D. Consequently, AMC connector 104C would not be utilized in the typical ATCA/AMC implementation depicted in FIG. 1.

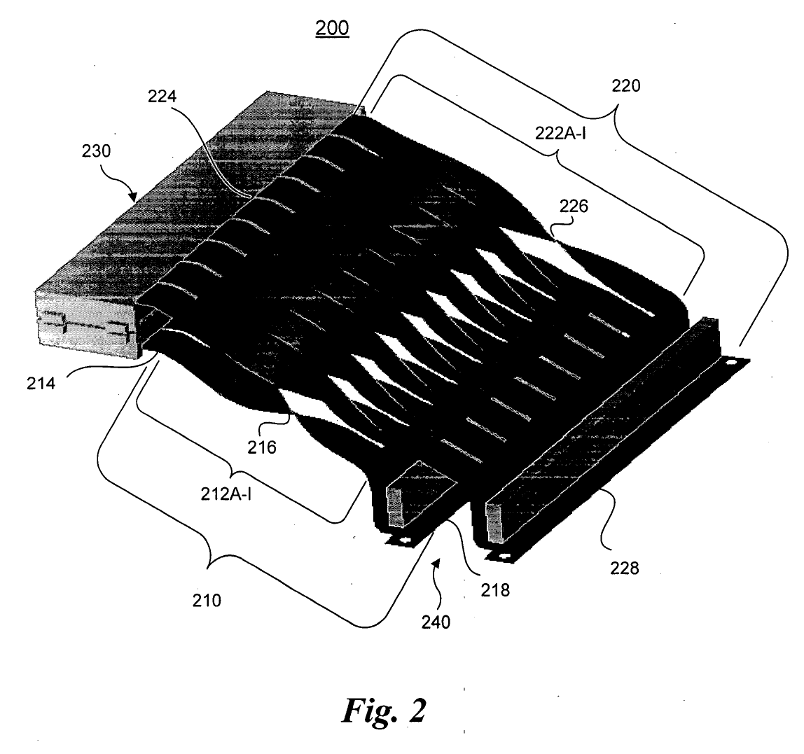

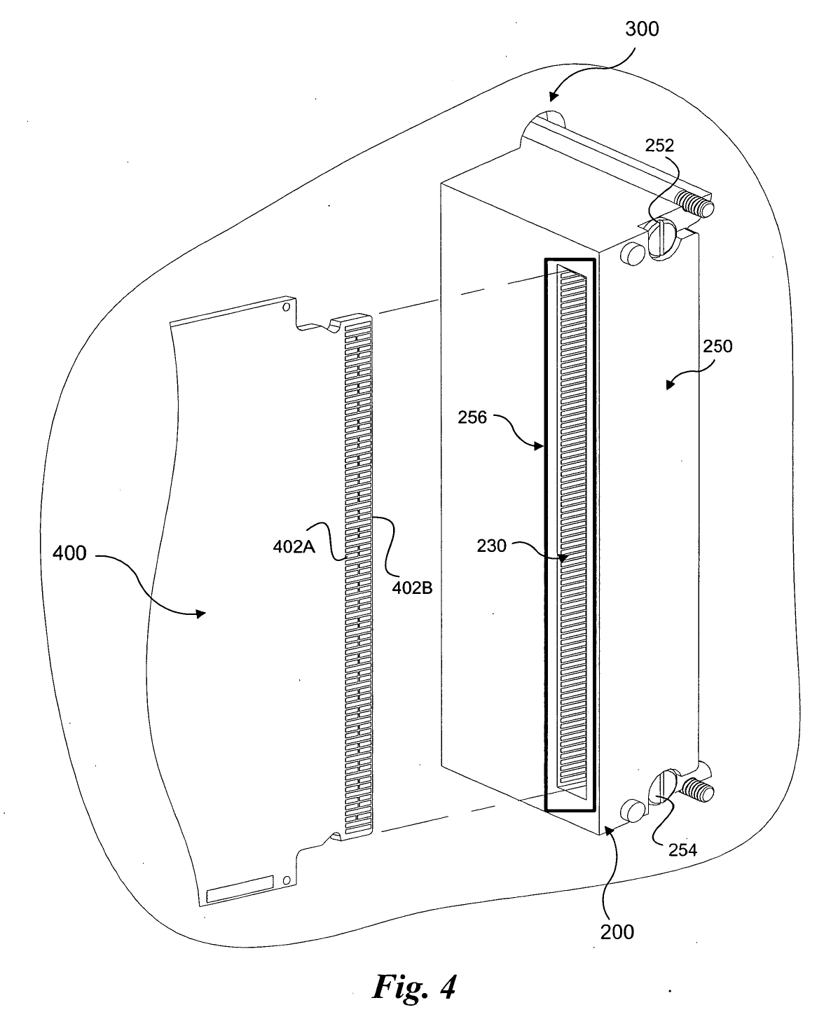

FIG. 2 is an isometric view of a connector 200, according to one embodiment. Connector 200 includes flexible circuits 210 and 220, and mating portions 230 and 240. Connector 200 also includes a connector housing which is not shown in FIG. 2 for clarity. However, the connector housing is depicted in FIG. 4 and described in more detail below.

Flexible circuits 210 and 220 are depicted in FIG. 2 as including end portions 214, 218, 224, 228 and middle portions 216 and 226. Additionally, flexible circuit 210 and 220 may be partitioned near middle portions 216 and 226, respectively. These partitions are depicted in FIG. 2 as partitions 212A-I and 222A-I. Mating portion 230 may couple to partitions 212A-I and 222A-I while mating portion 240 may couple to flexible circuit end portions 218 and 228.

In an alternative embodiment, flexible circuits 220 and 230 may be partitioned into individual flexible circuit partitions. As a result, one or more partitions at flexible circuit portions 214 and 224 may couple to a given contact of a device received and coupled to mating portion 230 and one or more partitions at flexible circuit portions 218 and 228 may couple to a given contact of another device received and coupled to mating portion 240.

In one embodiment, a flexible circuit may include a plurality of flexible film circuits and/or coaxial cables. A flexible circuit partition may include one or more of these flexible film circuits and/or coaxial cables. Each flexible film circuit or coaxial cable may include, but is not limited to, a conductive material surrounded by an insulating material and/or a shielding material. The conductive material may couple the contacts of a device received and coupled to mating portion 230 to the contacts of a device received and coupled to mating portion 240. This conductive material may also provide the medium via which I/O signals, power, etc. are routed between the two devices.

In one embodiment, each partition of partitions 212A-I and 222A-I may be rotated and coupled to mating portion 230 to create a twist. This twist may increase the range of movement in which mating portion 230 may receive and couple to a device's contacts. For example the range of movement may be increased along all three axes of movement. A first axis may be up and down, a second axis may be forward and backwards and a third axis may be from left to right. In a three-dimensional rectangular coordinate system with x, y and z axes, up and down may correspond to the y axis, forward and backwards the x axis, and left to right the z axis, although the descriptions of range of movement are not limited in this regard.

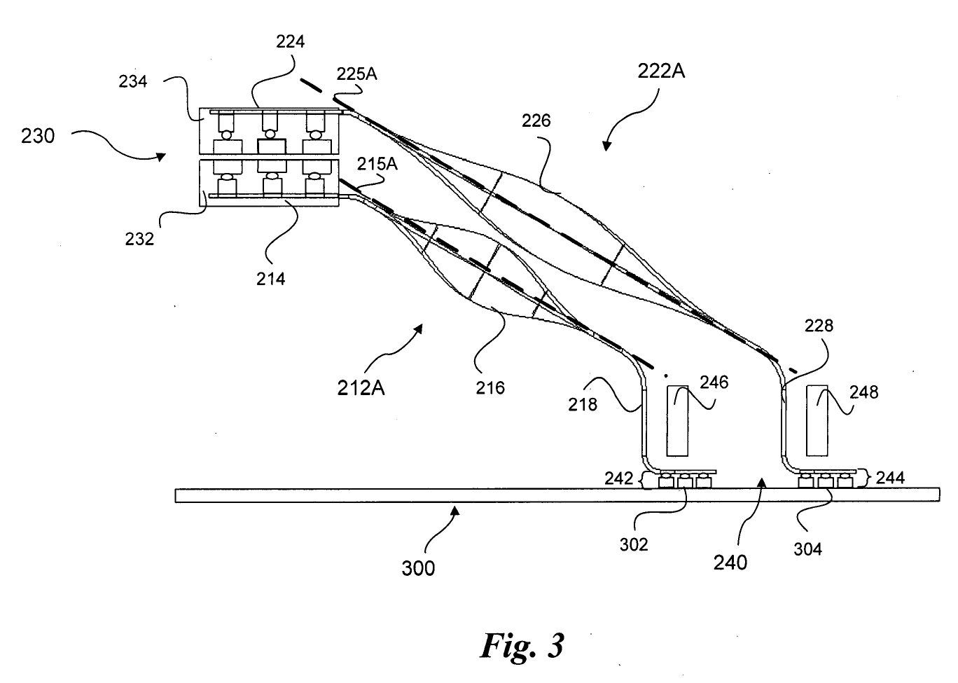

FIG. 3 is a side view of an example portion of connector 200 coupled to an example portion of a carrier board 300, according to one embodiment. Mating portions 230 and 240 are depicted in FIG. 3 as including interfaces 232, 234, 246 and 248. Mating portion 240 also includes stiffeners 246 and 248.

As mentioned previously, in one embodiment, flexible circuits 210 and 220 may be partitioned near middle portions 216 and 226, respectively. Accordingly, twisted partition 212A may couple to interface 232 at flexible circuit end 214 and twisted partition 222A may couple to interface 234 at flexible circuit end 224. Additionally, flexible circuit ends 218 and 228 may couple to interfaces 242 and 244, respectively.

In one embodiment, stiffener 246 may facilitate a secure coupling of flexible circuit end 218 to interface 242 and to device 300's contacts 302. Stiffener 248 may facilitate a secure coupling of flexible circuit end 228 to interface 244 and to device 300's contacts 304.

In one embodiment, connector 200 may receive and couple an AMC module with extended contacts (contacts on both sides). For example, interface 232 may couple to partition 212A and may then receive and couple to a contact on one side of an AMC module. Interface 234 may couple to partition 222A and may then receive and couple partition 222A to a contact on the other side of the AMC module. Additionally, interfaces 242 and 244 may receive and couple one or more contacts on an ATCA/AMC carrier board to flexible circuit ends 218 and 228, respectively.

The twist in partitions 212A and 222A may increase a range of movement in which mating portion 230 can receive and couple the AMC module's contact. As described above, the range of movement enabled by the twist may be increased along three axes of movement. This increased range of movement may occur without a proportional increase in movement of partitions 212A and 222A where coupled to interfaces 232 and 234, respectively. As a result, the AMC module's contacts may more accurately couple to interfaces 232 and 234. This accurate coupling may occur even if mating portion 230 is moved along any of the three axes of movement to receive those module contacts.

The increased range of movement enabled by the twist may also occur without a proportional increase in movement of flexible circuit ends 218 and 228 where coupled to interfaces 242 and 244, respectively. The twist may also facilitate interfaces 242 and 244 maintaining an accurate coupling to contacts 302 and 304, respectively, even if mating portion 230 is moving to receive and couple to the module's contacts.

In one implementation, a twist is created by the rotation of a partition along the partition's longitudinal axis. For example, partition 212A may comprise a substantially flat flexible circuit with longitudinal axis 215A. In order to create a twist and yet facilitate a flush and/or secure coupling to interface 232, an end of partition 212A is rotated approximately 180 degrees along longitudinal axis 215A. This rotation occurs, for example, while flexible circuit end 218 is securely fastened to interface 242. Once rotated, the end of partition 212A may be coupled to interface 232 to maintain the shape of the twist.

A twist along a partition's longitudinal axis may be created at either end of a partition and is not limited only to a rotation of 180 degrees. The rotation may be greater or lesser than 180 degrees depending on such factors, for example, as the shape of the flexible circuit partition (e.g., flat) and the relative positioning of the two mating portions to each other (e.g., parallel or perpendicular).

FIG. 4 is an isometric view of module 400's contacts to be received and coupled to connector 200 on the example portion of carrier board 300, according to one embodiment. FIG. 4 depicts connector 200 including connector housing 250. Connector housing 250 includes fasteners 252 and 254. Fasteners 252 and 254, for example, couple connector housing 250 to carrier board 300.

In one embodiment, module 400 includes module contacts 402A and 402B. As shown in FIG. 4, mating portion 230 is to receive module contacts 402A and 402B. Once received, mating portion 230 may couple module contacts 402A to interface 232 and module contacts 402B to interface 234. Mating portion 230 is housed/contained within connector housing 250 such that mating portion 230 is able to move within three axes of movement to receive and couple module contacts 402A and 402B to interfaces 232 and 234, respectively. This range of movement, for example, may be bounded or limited by an opening 256 in connector housing 250.

In one embodiment, connecter 200 may be a connector on an ATCA carrier board to receive and couple the contacts on a rear transition module (not shown) to the interfaces in mating portion 230, although the connectors described herein are not limited to ATCA carrier board connectors that receive and couple to the contacts of rear transition modules and/or other modules.

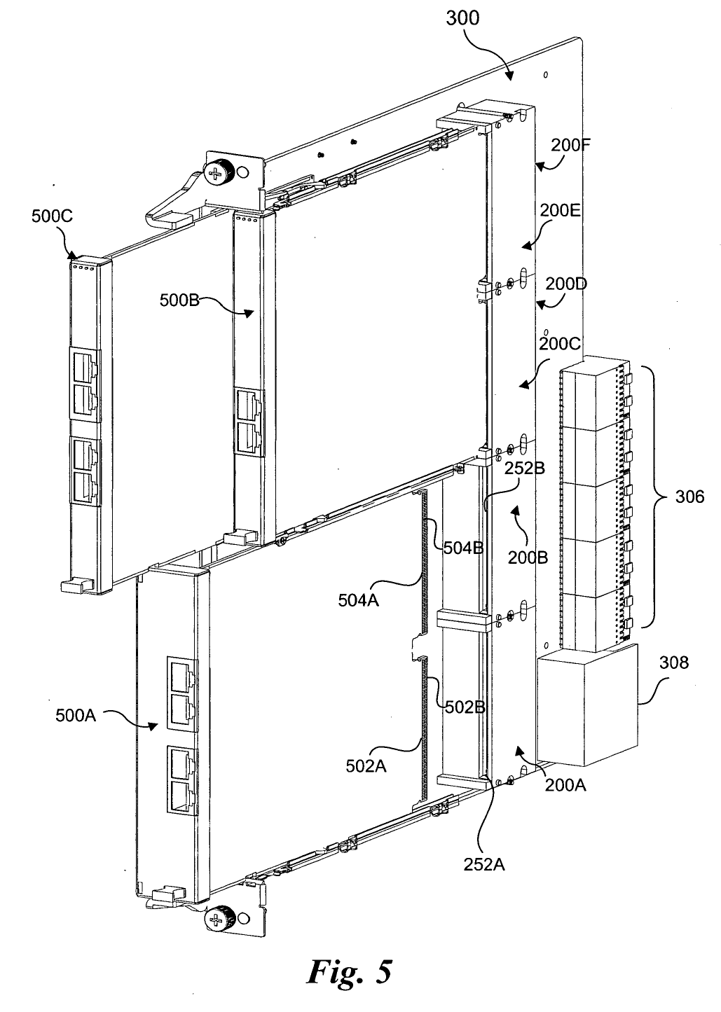

FIG. 5 is an isometric view of carrier board 300 in which dual-width modules 500A-C are to couple to connectors 200A-F, according to one embodiment. Similar to carrier board 100 depicted in FIG. 1, carrier board 300 may be compliant with both the ATCA and AMC.0 specifications. In that regard, carrier board 300 includes power and I/O interfaces (e.g., power interface 308 and I/O interface 306).

In one embodiment, modules 500A-C are dual-width front accessible modules. Modules 500A-C may each include two sets of module contacts. For example, module 500A includes a first set of module contacts 502A and 502B and also includes a second set of module contacts 504A and 504B. As shown in FIG. 5, these module contacts are to be received and coupled to carrier board 300 via connectors 200A and 200B.

In one embodiment, opening 252A may be large enough to allow mating portion 230A to move within connector housing 250A to couple and receive module contacts 502A and 502B to interfaces 232A and 234A (not shown), respectively. The dimensions of opening 252A may be, for example, sufficient to compensate for mechanical tolerances permitted by the ATCA/AMC.0 specifications.

In one embodiment, module 500A may be designed to logically appear as a single module resident on carrier board 300. Even though module 500A is physically coupled to both connectors 200A and 200B, module 500A may be managed as a single module, for example, by control logic (not shown) responsive to carrier board 300. As a result, module 500A may utilize the contacts previously dedicated to enable the management of two modules. For example, contacts via which communications are routed may be reallocated to provide more contacts for I/O and/or other types of communications. Module 500A may also utilize the additional power that can be provided through two connectors as opposed to one connector.

FIG. 6 provides a partial view of a modular platform 600 in which carrier board 300 is received and coupled to a backplane 602, according to one embodiment. Modular platform 600 may be a telecommunications server designed to be complaint with the ATCA specification, although the scope of the embodiments described herein are not limited in this respect. FIG. 6 shows a partial view of modular platform 600 having selected portions removed for clarity.

Modular platform 600 is depicted in FIG. 6 as including carrier board 300 as well as carrier board 610 and board 620. Each of these boards is coupled to backplane 602 to enable components on a given board (e.g. module 500A on carrier board 300) to communicate with components on other boards and/or interconnects coupled to backplane 602.

In the previous descriptions, for the purpose of explanation, numerous specific details were set forth in order to provide a thorough understanding of the invention. It will be apparent, however, to one skilled in the art, that the invention can be practiced without these specific details.

References made in the specification to the term “responsive to” are not limited to responsiveness to only a particular feature and/or structure. A feature may also be “responsive to” another feature and/or structure and also be located within or resident on that feature and/or structure. Additionally, the term “responsive to” may also be synonymous with other terms such as “communicatively coupled to” or “operatively coupled to”, although the term is not limited in this regard.

References made in the specification to “one embodiment” or “an embodiment” means that a particular feature, structure or characteristic described in connection with that embodiment is included in at least one embodiment of the invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily referring to the same embodiment.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative of, rather than limiting the scope and coverage of the claims appended hereto.

1-18. (canceled)

19. A system comprising:
a carrier board to couple to a backplane;
a module; and
a connector resident on the carrier board, wherein the connector further comprises;
a flexible circuit including a first end partitioned near the middle and a second end;
a first mating portion to receive and couple a contact for the module to the first end of the flexible circuit;
a second mating portion to receive and couple a contact for the carrier board to the second end of the flexible circuit, wherein the first end of the flexible circuit includes a twist to each partition, the twist to increase a range of movement along three axes of movement in which the first mating portion receives and couples the module's contact to the first end of the flexible circuit without a proportional increase in movement of the first and second ends of the flexible circuit; and
a connector housing connected to the carrier board to contain the first and second mating portions.

20. The system of claim 19, wherein the first mating portion further comprises:
an interface coupled to the first end, the interface to receive the contact for the module.

21. The system of claim 20, wherein the twist results from a rotation along each partition's longitudinal axis before the first end is coupled to the interface.

22. The system of claim 19, wherein the backplane and the carrier board are compliant with the Advanced Telecommunications Computing Architecture Base specification.

23. The system of claim 22, wherein the module is an Advanced Mezzanine Card (AMC) module and both the carrier board and the AMC module are compliant with the AMC.0 specification.

24. The system of claim 22, wherein the AMC module includes extended type contacts to be received and coupled to the first mating portion.

25. The system of claim 19, wherein the flexible circuit comprises a flexible film circuit.

26. The system of claim 19, wherein the flexible circuit comprises a coaxial cable.

27. The system of claim 19, wherein the connector housing comprise the connector housing including an opening in which the range of movement along three axes of movement is limited.
